(19) United States
(12) Patent Application Publication
(10) Pub. No.: US 2019/0102697 A1
(43) Pub. Date: Apr. 4, 2019

(54) CREATING MACHINE LEARNING MODELS FROM STRUCTURED INTELLIGENCE DATABASES

(71) Applicant: International Business Machines Corporation, Armonk, NY (US)

(72) Inventors: Jean-Jerome Casalonga, Paris (FR); Marc Fiammante, Cagnes sur Mer (FR)

(21) Appl. No.: 15/722,196

(22) Filed: Oct. 2, 2017

(51) Int. Cl. G06N 99/00; G06F 17/30; G06F 17/20

(52) U.S. Cl. CPC G06N 99/005; G06N 5/027; G06F 17/20; G06F 17/30604

(57) ABSTRACT

An approach for creating an artificial intelligence machine learning model is provided. In an embodiment, a set of unstructured documents stored in an intelligence database is selected. Attributes associated with entities contained in the selected unstructured documents are retrieved from structured data that is also stored within the intelligence database. In addition, a natural language scan of the unstructured documents is performed to identify relationships between the entities. These relationships and the attributes are used to annotate the originally selected documents. Then the machine learning model is automatically created based on the annotated documents. This machine learning model can be used to train an AI to perform a specific set of problem solving tasks.

### TECHNICAL FIELD

In general, embodiments of the present invention relate to artificial intelligence (AI). Specifically, embodiments of the present invention relate to an approach for automatically creating a machine learning model for use in an AI system.

### BACKGROUND

In today's information technology environment, more and more activities that were previously performed by humans can be performed more quickly and efficiently by computers. These activities can include such tasks as performing complex calculations, monitoring various conditions and/or events, controlling machinery, providing automated navigation, and/or the like. One area in which the use of computers is currently expanding is the use of artificial intelligence (AI) in solving problems.

Generally, AI systems take inputted information and analyze the information according to a set of rules and/or other information in a machine learning model to arrive at a solution. As such, it is important that the information in the machine learning model be accurate. Further, the more comprehensive the information in the machine learning model is, the more likely it will be that the AI will arrive at a correct solution. It is generally accepted that a minimum of at least 50,000 words in 50 different documents is usually required to provide a sufficient amount of learning content for machine learning.

Because of these considerations, creating a machine learning model for a particular AI usually requires a large amount of time, effort, and other resources. For example, some current solutions for creating a machine learning model require annotating/tagging each element in an input sentence with tokens that target a particular purpose (e.g., Named Entity Recognition, Information Extraction, Text Chunking, etc.).

### SUMMARY

In general, an approach for creating an artificial intelligence machine learning model is provided. In an embodiment, a set of unstructured documents stored in an intelligence database is selected. Attributes associated with entities contained in the selected unstructured documents are retrieved from structured data that is also stored within the intelligence database. In addition, a natural language scan of the unstructured documents is performed to identify relationships between the entities. These relationships and the attributes are used to annotate the originally selected documents. Then the machine learning model is automatically created based on the annotated documents. This machine learning model can be used to train an AI to perform a specific set of problem solving tasks.

A first aspect of the present invention provides a method for creating an artificial intelligence machine learning model, comprising: selecting a set of unstructured documents stored in an intelligence database; retrieving attributes associated with the set of entities in the set of unstructured documents from structured data within the intelligence database; performing a natural language scan of the unstructured documents to identify relationships between the entities; annotating the unstructured documents with the attributes and the relationships; and forming the machine learning model based on the annotated documents.

A second aspect of the present invention provides a system for creating an artificial intelligence machine learning model, comprising: a memory medium comprising instructions; a bus coupled to the memory medium; and a processor coupled to the bus that when executing the instructions causes the system to: select a set of unstructured documents stored in an intelligence database; retrieve attributes associated with the set of entities in the set of unstructured documents from structured data within the intelligence database; perform a natural language scan of the unstructured documents to identify relationships between the entities; annotate the unstructured documents with the attributes and the relationships; and form the machine learning model based on the annotated documents.

A third aspect of the present invention provides a computer program product for creating an artificial intelligence machine learning model, the computer program product comprising a computer readable storage media, and program instructions stored on the computer readable storage media, that cause at least one computer device to: select a set of unstructured documents stored in an intelligence database; retrieve attributes associated with the set of entities in the set of unstructured documents from structured data within the intelligence database; perform a natural language scan of the unstructured documents to identify relationships between the entities; annotate the unstructured documents with the attributes and the relationships; and form the machine learning model based on the annotated documents.

A fourth aspect of the present invention provides a method for deploying a system for creating an artificial intelligence machine learning model, comprising: providing a computer infrastructure having at least one computer device that operates to: select a set of unstructured documents stored in an intelligence database; retrieve attributes associated with the set of entities in the set of unstructured documents from structured data within the intelligence database; perform a natural language scan of the unstructured documents to identify relationships between the entities; annotate the unstructured documents with the attributes and the relationships; and form the machine learning model based on the annotated documents.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing environment according to an embodiment of the present invention.

FIG. 2 depicts a system diagram according to an embodiment of the present invention.

FIG. 3 depicts an example annotation according to an embodiment of the present invention.

FIG. 4 depicts an example process flowchart according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Embodiments of the present invention provide an approach for creating an artificial intelligence machine learning model. In an embodiment, a set of unstructured documents stored in an intelligence database is selected. Attributes associated with entities contained in the selected unstructured documents are retrieved from structured data that is also stored within the intelligence database. In addition, a natural language scan of the unstructured documents is performed to identify relationships between the entities. These relationships and the attributes are used to annotate the originally selected documents. Then the machine learning model is automatically created based on the annotated documents. This machine learning model can be used to train an AI to perform a specific set of problem solving tasks.

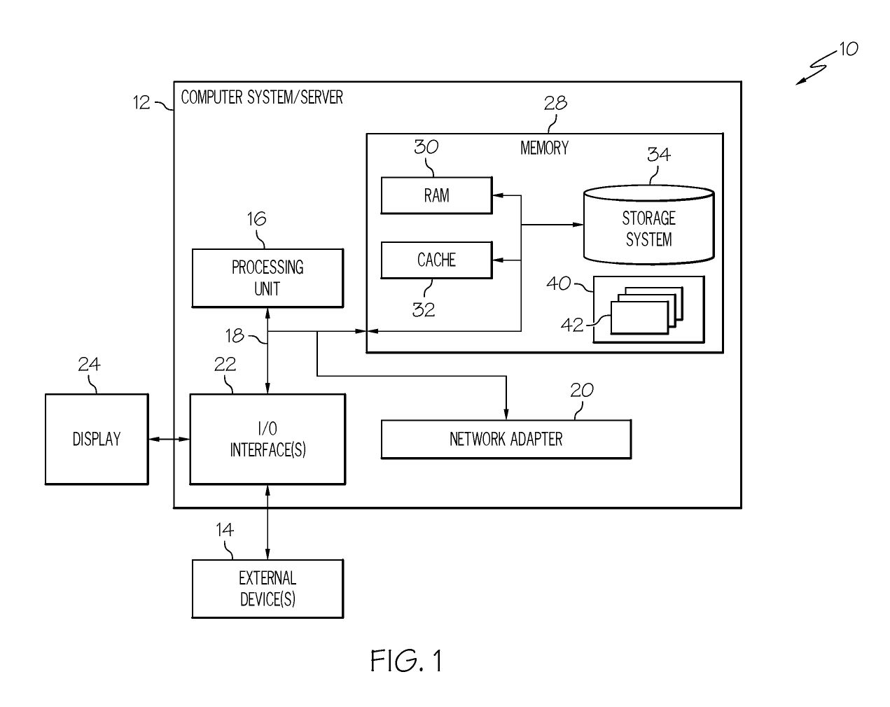

Referring now to FIG. 1, a schematic of an example of a computing environment is shown. Computing environment 10 is only one example of a suitable computing environment and is not intended to suggest any limitation as to the scope of use or functionality of embodiments of the invention described herein. Regardless, computing environment 10 is capable of being implemented and/or performing any of the functionality set forth hereinabove.

In computing environment 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, distributed cloud computing environments that include any of the above systems or devices, and/or the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in computing environment 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), an optical disk drive for reading from or writing to a removable, non-volatile optical disk such as a CD-ROM, DVD-ROM, and/or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

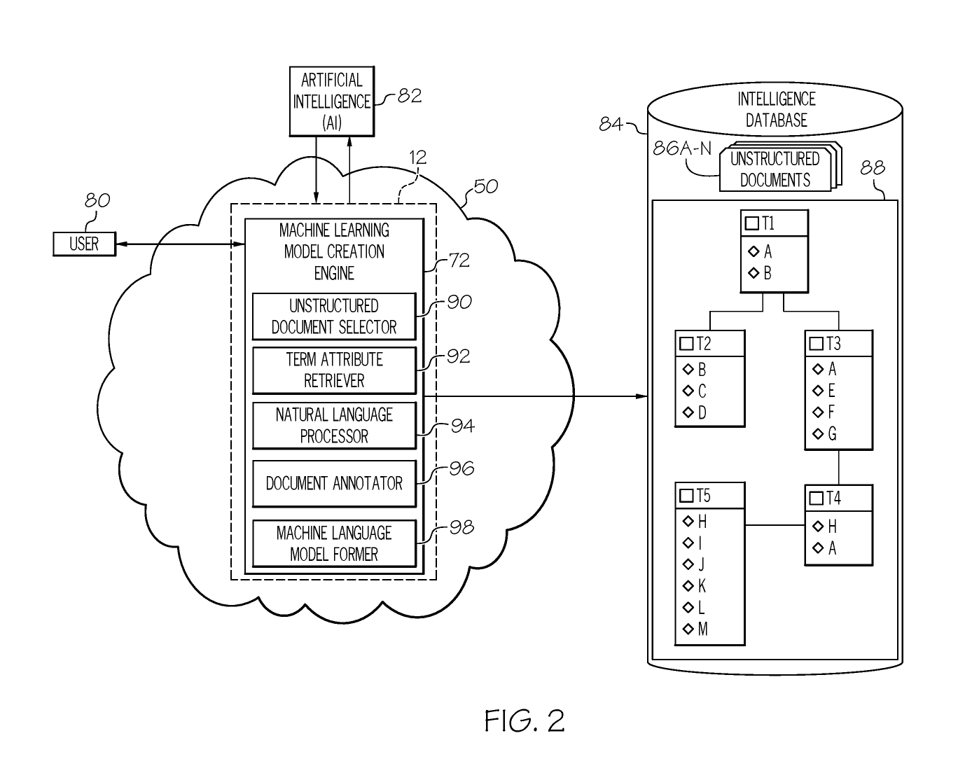

Referring now to FIG. 2, a system diagram describing the functionality discussed herein according to an embodiment of the present invention is shown. It is understood that the teachings recited herein may be practiced within any type of networked computing environment 70 (e.g., a cloud computing environment 50). A stand-alone computer system/server 12 is shown in FIG. 2 for illustrative purposes only. In the event the teachings recited herein are practiced in a networked computing environment 70, each client need not have a machine learning model creation engine (hereinafter “system 72”). Rather, system 72 could be loaded on a server or server-capable device that communicates (e.g., wirelessly) with the clients to machine learning model creation therefor. Regardless, as depicted, system 72 is shown within computer system/server 12. In general, system 72 can be implemented as program/utility 40 on computer system 12 of FIG. 1 and can enable the functions recited herein. It is further understood that system 72 may be incorporated within or work in conjunction with any type of system that receives, processes, and/or executes commands with respect to IT resources in a networked computing environment. Such other system(s) have not been shown in FIG. 2 for brevity purposes.

Along these lines, system 72 may perform multiple functions similar to a general-purpose computer. Specifically, among other functions, system 72 can create a machine learning model for an artificial intelligence system 82. To accomplish this, system 72 can include: an unstructured document selector 90, a term attribute retriever 92, a natural language processor 94, a document annotator 96, and a machine language model former 98.

Referring again to FIG. 2, unstructured document selector 90 of system 72, as executed by computer system/server 12, is configured to select a set of unstructured documents 86A-N stored in an intelligence database 84. In an embodiment, intelligence database 84 can use any type of database structure (e.g., relational, hierarchical, etc.) to store structured data 88 about entities and/or relationship between entities. This structured data 88 is usually manually extracted from unstructured documents 86A-N and manually copied into structured data 88 portion of intelligence database 84, with corrections for things such as typographical errors. The structured nature of structured data 88 allows entity attributes to be entered and some of the relationships between the entities that are described in these unstructured documents 86A-N to be created. In many cases, intelligence database 84 continues to retain the unstructured documents 86A-N that were used as the source of the structured data 88 in the same intelligence database 84.

In any case, unstructured documents 86A-N refer to any passage that conveys informational content in a text-based format, without including computer-readable indexing, annotations, tagging, etc., of the text contained therein. To this extent, each unstructured document could be one or more phrases, clauses, sentences, paragraphs, pages, etc., and/or the like. Whatever the case, unstructured document selector 90 can use any criteria now known or later discovered to select unstructured documents 86A-N from intelligence database 84. For example, in an embodiment, all unstructured documents 86A-N contained in intelligence database 84 could be selected. Alternatively, a pre-determined number of unstructured documents 86A-N (e.g., 50) and/or unstructured documents 86A-N having a predetermined number of words (e.g., 50,000) could be selected. In such a case, the unstructured documents 86A-N that are selected could be selected based on a variety of different factors including, but not limited to: longest documents, shortest documents, documents of a pre-determined size, most recent documents, oldest documents, documents that have the largest number of entities in structured data 88, and/or the like.

The inventors of the invention described herein have discovered certain deficiencies in the current solutions for creating artificial intelligence machine learning models. For example, some current solutions for creating a machine learning model require a user 80 to tag each element in an input sentence with one or more tokens that target a particular purpose for which an AI 82 is being developed (e.g., Named Entity Recognition, Information Extraction, Text Chunking, etc.). However, the resulting tokens can have formats that may be difficult for user 80 inputting them to interpret, making the input process difficult. For example, assume that a machine learning model to perform targeting birthplace recognition with Conditional Random Fields (CRFs) is being created for AI 82 using the following sentence “Bob was born in New York City, N.Y.” The annotating token could take the following form:

Bob NNP PERSON TYPEA SUBJECT
was VBD 0 TYPEA 0
born VBN 0 TYPEA 0
in IN 0 TYPEA 0
New NNP LOC TYPEA BIRTHPLACE
York NNP LOC TYPEA BIRTHPLACE
City NNP LOC TYPEA BIRTHPLACE
, , 0 TYPEA BIRTHPLACE
New NNP LOC TYPEA BIRTHPLACE
York NNP LOC TYPEA BIRTHPLACE
. . 0 TYPEA 0

Given that a minimum of at least 50,000 words in 50 different documents is usually required to provide a sufficient amount of learning content for machine learning, manually creating a machine learning model for a particular AI 82 usually requires a large amount of time, effort, and other resources.

To this extent, the present invention utilizes the combination of unstructured documents 86A-N and structured data 88 in the same intelligence database 84 to automatically create a machine learning model for AI 82. This allows machine learning models, which are customized to train AI 82 to perform a specific set of problem solving tasks, to be created using a fraction of the time and effort that manual data entry, specification of attributes, and identifying of relationships would require.

Referring still to FIG. 2, entity attribute retriever 92 of system 72, as executed by computer system/server 12, is configured to retrieve attributes associated with entities located in unstructured data 86A-N from structured data 88 in intelligence database 84. In order to accomplish this, the entities that are included within unstructured documents 86A-N are identified. In an embodiment, unstructured documents 86A-N are forwarded to an external tokenizer, which has the ability to extract the nouns, verbs, and/or elements of other parts of speech. To this extent, the external tokenizer can be one or more of several natural language processing systems, including, but not limited to: unstructured information management architecture (UIMA) tokenizer (e.g., Watson Content Analytics or the like), a Stanford Natural Language Processer (NLP), Apache Opennip, and/or the like. (Watson and Watson Content Analytics are registered trademarks of International Business Machines, Armonk, N.Y., in the United States, other countries, or both. Stanford is a registered trademark of Board of Trustees of Leland Stanford Junior University, Stanford, Calif., in the United States, other countries, or both. Apache is a trademark of the Apache group in the United States, other countries, or both.) In any case, the external tokenizer can return all nouns that have been extracted from unstructured documents 86A-N and these nouns can be designated as the entities.

In any case, once the entities are determined, entity attribute retriever 92 can retrieve attributes, if any, that are applicable to each of the entities from structured data 88. For example, entity attribute retriever 92 can perform a search of structured data 88 for each entity. This search can search structured data 88 for an exact match with an entity. Alternatively, a fuzzy logic search, which can detect differences (e.g., spelling corrections, typographic errors, and/or the like) between unstructured documents 86A-N and structured data 88 can be utilized. This fuzzy logic search can be performed using a trigram or other n-gram search, Levenshtein distance, or any other solution now known or later developed.

Whatever the case, if an entity from unstructured document 86A-N is found in structured data 88, any attributes associated with the entity in structured data 88 can be retrieved. As stated earlier, these entity attributes, as well as many of the relationships between the entities, are already included in structured data 88 due to the structured nature thereof. For example, in relational databases, each data item in a table has an attribute name that describes the data item (e.g., first name, last name, gender, age, etc.). Further, other attributes included within the structure of structured data 88 can include, but are not limited to: an entity to which an entity belongs, an attribute type, a relationship to a document, a semantic of an attribute, a semantic of the entity, and a value of an attribute. Any or all of these attributes can be associated with the entity by entity attribute retriever 92.

Natural language processor 94 of system 72, as executed by computer system/server 12, is configured to perform a natural language scan of unstructured documents 86A-N to identify relationships between the entities. As stated above, certain relationships between entities can be included within the structure of structured data 88. However, natural language processor 94 is able to analyze the language of unstructured documents 86A-N to identify any relationships that may be indicated by the text of the unstructured document 86N. In an embodiment, natural language processor 94 may utilize Watson Content Analytics, Apache UIMA. In any case, natural language processor 94 can analyze a set of words in unstructured document 86A-N that connect a first entity and a second entity within the unstructured document 86A-N. Based on the results of this analysis, natural language processor 94 can identify any relationships between the two entities indicated by the informational content of the analyzed set of words.

Document annotator 96 of system 72, as executed by computer system/server 12, is configured to annotate unstructured documents 86A-N with the attributes and the relationships. Annotations can take the form of tags, tokens, or any other solution for annotating a document that is now known or later developed. In any case, the annotated documents that are automatically generated as the result of the annotating can have the same types of information and have the same format as those previously input manually. As such, the annotated documents are as suitable as their manually generated counterparts for creating a machine learning model for training AI 82. To this extent, these annotations can include not only attributes that apply to a single entity, but also can document the relationship between two entities in the tokens associated with each of the entities.

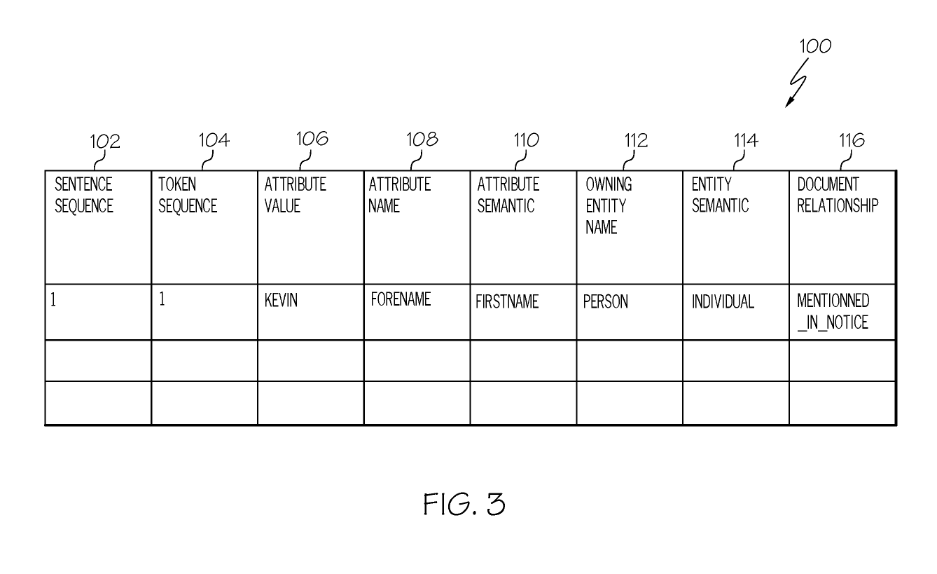

Referring now to FIG. 3, an example annotation 100 is shown according to an embodiment of the present invention. As shown, annotation 100 includes an attribute value 106 corresponding to the entity. Further, annotation 100 also includes a sentence sequence 102 and a token sequence 104 that indicate a location of the entity within the unstructured document 86N (FIG. 2). Also included in annotation 100 are attribute name 108 and attribute semantic 110, which indicate what the entity is; owning person entity 112, which indicates the type of entity that the entity belongs to; an entity semantic 114, which indicates the root semantic of the entity type (can be identical to the type); and a document relationship 116, which indicates the relationship of the entity to the unstructured document 86N (FIG. 2).

Referring again to FIG. 2, machine language model former 98 of system 72, as executed by computer system/server 12, is configured to form the machine learning model based on the annotated documents. To this extent, the machine learning model formed by machine language model former 98 includes the set of selected unstructured documents 86A-N, the entities of which have been annotated with attributes and relationships. In an embodiment, one or more of these annotated documents can be parsed to remove portions of the document that are not annotated prior to the document's incorporation into the machine language model. In any case, as stated above, the annotated documents that form the machine language model are as suitable as their manually generated counterparts for training AI 82. As such, after the machine language model has been formed, this machine language model can be used to train AI 84 to perform the required task.

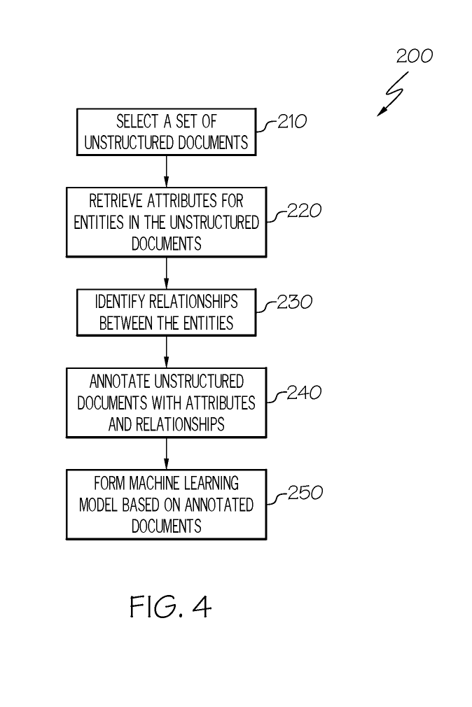

Referring now to FIG. 4 in conjunction with FIG. 2, a method flow diagram 200 according to an embodiment of the present invention is shown. At 210, unstructured document selector 90 of system 72, as executed by computer system/server 12, selects a set of unstructured documents 86A-N stored in an intelligence database 84. At 220, term attribute retriever 92 of system 72, as executed by computer system/server 12, retrieves attributes associated with a set of entities in the set of unstructured documents 86A-N from structured data 88 within the intelligence database 84. At 230, natural language processor 94 performs a natural language scan of the unstructured documents 86A-N to identify relationships between the entities. At 240, prevention performer 96 of system 72, as executed by computer system/server 12, annotates the unstructured documents 86A-N with the attributes and the relationships. At 250, machine language model former 98 of system 72, as executed by computer system/server 12, forms the machine learning model based on the annotated documents.

The flowchart of FIG. 4 illustrates the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

While shown and described herein as an approach for creating an artificial intelligence machine learning model, it is understood that the invention further provides various alternative embodiments. For example, in one embodiment, the invention provides a method that performs the process of the invention on a subscription, advertising, and/or fee basis. That is, a service provider, such as a Solution Integrator, could offer to provide functionality for responding to a threat. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In another embodiment, the invention provides a computer-implemented method for creating an artificial intelligence machine learning model. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, availability detector 118 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may also be a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

It is apparent that there has been provided approaches for creating an artificial intelligence machine learning model. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A method for creating an artificial intelligence machine learning model, comprising:
selecting a set of unstructured documents stored in an intelligence database;
retrieving attributes associated with a set of entities in the set of unstructured documents from structured data within the intelligence database;
performing a natural language scan of the unstructured documents to identify relationships between the entities;
annotating the unstructured documents with the attributes and the relationships; and
forming the machine learning model based on the annotated documents.

2. The method of claim 1, the method further comprising:
forwarding the unstructured documents to an external tokenizer;
retrieving, from the external tokenizer, a set of extracted words that are nouns from the unstructured documents; and
designating the set of extracted words as the set of entities.

3. The method of claim 1, wherein the attributes are retrieved from the intelligence database include attribute names for the entities in the structured data.

4. The method of claim 3, wherein the attributes further include an entity to which an entity belongs, an attribute type, a relationship to a document, a semantic of an attribute, a semantic of the entity, and a value of an attribute.

5. The method of claim 1,
wherein the identifying of the relationship further comprises analyzing a set of words in an unstructured document that connect a first entity and a second entity within the unstructured document, and
wherein the annotating further comprises documenting the relationship in a first token associated with the first entity and in a second token associated with a second entity.

6. The method of claim 1, further comprising training the artificial intelligence using the machine learning model.

7. The method of claim 1, further comprising parsing, prior to the forming of the machine language model, the annotated documents to remove from a document unannotated portions of the document.

8. A system for creating an artificial intelligence machine learning model, comprising:
a memory medium comprising instructions;
a bus coupled to the memory medium; and
a processor coupled to the bus that when executing the instructions causes the system to:
select a set of unstructured documents stored in an intelligence database;
retrieve attributes associated with a set of entities in the set of unstructured documents from structured data within the intelligence database;
perform a natural language scan of the unstructured documents to identify relationships between the entities;
annotate the unstructured documents with the attributes and the relationships; and
form the machine learning model based on the annotated documents.

9. The system of claim 8, the instructions further causing the system to:
forward the unstructured documents to an external tokenizer;
retrieve, from the external tokenizer, a set of extracted words that are nouns from the unstructured documents; and
designate the set of extracted words as the set of entities.

10. The system of claim 8, wherein the attributes retrieved from the intelligence database include attribute names for the entities in the structured data.

11. The system of claim 10, wherein the attributes further include an entity to which an entity belongs, an attribute type, a relationship to a document, a semantic of an attribute, a semantic of the entity, and a value of an attribute.

12. The system of claim 8,
wherein the identifying of the relationship further comprises analyzing a set of words in an unstructured document that connect a first entity and a second entity within the unstructured document, and
wherein the annotating further comprises documenting the relationship in a first token associated with the first entity and in a second token associated with a second entity.

13. The system of claim 8, the instructions further causing the system to train the artificial intelligence using the machine learning model.

14. The system of claim 8, the instructions further causing the system to parse, prior to the forming of the machine language model, the annotated documents to remove from a document unannotated portions of the document.

15. A computer program product for creating an artificial intelligence machine learning model, the computer program product comprising a computer readable storage media, and program instructions stored on the computer readable storage media, that cause at least one computer device to:
select a set of unstructured documents stored in an intelligence database;
retrieve attributes associated with a set of entities in the set of unstructured documents from structured data within the intelligence database;
perform a natural language scan of the unstructured documents to identify relationships between the entities;
annotate the unstructured documents with the attributes and the relationships; and
form the machine learning model based on the annotated documents.

16. The computer program product of claim 15, the instructions further causing the at least one computer device to:
forward the unstructured documents to an external tokenizer;
retrieve, from the external tokenizer, a set of extracted words that are nouns from the unstructured documents; and
designate the set of extracted words as the set of entities.

17. The computer program product of claim 16, wherein the attributes retrieved from the intelligence database include attribute names for the entities in the structured data, an entity to which an entity belongs, an attribute type, a relationship to a document, a semantic of an attribute, a semantic of the entity, and a value of an attribute.

18. The computer program product of claim 15,
wherein the identifying of the relationship further comprises analyzing a set of words in an unstructured document that connect a first entity and a second entity within the unstructured document, and
wherein the annotating further comprises documenting the relationship in a first token associated with the first entity and in a second token associated with a second entity.

19. The computer program product of claim 15, the instructions further causing the at least one computer device to train the artificial intelligence using the machine learning model.

20. The computer program product of claim 15, the instructions further causing the at least one computer device to parse, prior to the forming of the machine language model, the annotated documents to remove from a document unannotated portions of the document.
